(19) United States
(12) Patent Application Publication
(10) Pub. No.: US 2010/0092116 A1
(43) Pub. Date: Apr. 15, 2010

(54) PRESSURE BALANCED VALVE ASSEMBLY AND AIRCRAFT BUFFER COOLER SYSTEM EMPLOYING THE SAME

(75) Inventor: Robert B. Franconi, New Hartford, CT (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc., Morristown, NJ (US)

(21) Appl. No.: 12/252,149

(22) Filed: Oct. 15, 2008

(51) Int. Cl. F16C 37/00; F16K 11/065

(52) U.S. Cl. 384/317; 137/625.4

(57) ABSTRACT

A pressure balanced valve assembly is provided. In one embodiment, the pressure balanced valve assembly includes a housing assembly having first and second seats. A flow passage formed through the housing assembly includes a first inlet, a second inlet, and an outlet. A piston is slidably mounted in the housing assembly for movement between: (i) a first position wherein the piston contacts the second seat to restrict fluid flow from the second inlet to the outlet, and (ii) a second position wherein the piston contacts the first seat to restrict fluid flow from the first inlet to the outlet. First and second dynamic seals are mounted in the housing assembly. The first and second dynamic seals sealingly engage first and second portions of the piston over areas substantially equivalent to the sealing areas of the second and first seats, respectively.

### TECHNICAL FIELD

The present invention relates generally to aircraft systems and, more particularly, to a pressure balanced valve assembly suitable for deployment within an aircraft buffer cooler system.

### BACKGROUND

A gas turbine engine (GTE) is commonly equipped with a lubrication system that continually circulates a lubricant, typically oil, through the GTE's bearing assemblies. The lubrication system may include, for example, an oil tank; a spray bar mounted within the bearing housing above the bearing or bearings contained therein; and a supply pump fluidly coupled between the oil tank and the spray bar. When energized, the supply pump draws oil from the oil tank and supplies the oil to the spray bar, which then directs the oil over the bearing assembly's bearings. After flowing through the bearings, the oil collects within a sump provided at the bottom of the bearing housing. The oil is then returned to the oil tank, and the process is repeated.

The GTE bearing assemblies may further include a plurality of seals (e.g., carbon seals) mounted within the bearing housing. When properly energized, such seals minimize the leakage of oil from the bearing housing. To maintain the seals in a properly energized state, pressurized air may be supplied to the bearing compartment by an aircraft buffer system. The aircraft buffer system may be fluidly coupled between the bearing assembly, and more specifically an air cavity provided within the bearing assembly above the sump, and a selected stage of the GTE compressor. During operation, the aircraft buffer cooler system bleeds pressurized air from the GTE compressor, cools the bleed air utilizing a specialized heat exchanger (commonly referred to as a “buffer cooler”), and then supplies the cooled, pressurized air to the air cavity provided within the bearing assembly.

Depending upon the particular compressor stage from which the buffer cooler system draws pressurized air, the air pressure within the selected GTE compressor stage may become undesirably high or undesirably low during GTE operation for the purposes of pressurizing the bearing assembly's air cavity. For example, if the aircraft buffer cooler system is configured to draw pressurized air from a higher compressor stage (e.g., the 6^{th} stage of an aircraft compressor), the air pressure within the selected compressor stage may be ideal for pressurizing the bearing assembly during low engine speed conditions, such as engine start and flight idle; however, the pressure within the higher compressor stage may become undesirably high during high engine speed conditions, such as aircraft takeoff and climb. Conversely, if the aircraft buffer system is configured to bleed pressurized air from a lower compressor stage (e.g., the 4^{th} stage), the air pressure within the selected pressure stage may be ideal during high engine speed conditions and undesirably low during low engine speed conditions. A conventional aircraft buffer cooler system may consequently permit the pressure within a bearing assembly to become undesirably high or low during certain junctures in the flight regime. The seals of the bearing assembly may thus become de-energized, and oil leakage may occur.

It is thus desirable to provide an aircraft buffer cooler system suitable for continually supplying a bearing assembly with pressurized air within a desired pressure range by, for example, routing airflow to the bearing assembly from a higher stage of a GTE compressor (e.g., the 6^{th} stage) during low engine speed conditions and from a lower stage of a GTE compressor (e.g., the 4^{th} stage) during high engine speed conditions. It would also be desirable to provide a valve assembly suitable for deployment within such an aircraft buffer cooler system. Preferably, such a valve assembly would be pressurized balanced to both the high GTE compressor stage and the low GTE compressor stage so as to minimize or eliminate the effect of pressure variations during GTE operation. Other desirable features and characteristics of the present invention will become apparent from the subsequent detailed description of the invention and the appended claims, taken in conjunction with the accompanying drawings and this background of the invention.

### BRIEF SUMMARY

A pressure balanced valve assembly is provided. In one embodiment, the pressure balanced valve assembly includes a housing assembly having first and second seats. A flow passage formed through the housing assembly includes a first inlet, a second inlet, and an outlet. A piston is slidably mounted in the housing assembly for movement between: (i) a first position wherein the piston contacts the second seat to restrict fluid flow from the second inlet to the outlet, and (ii) a second position wherein the piston contacts the first seat to restrict fluid flow from the first inlet to the outlet. First and second dynamic seals are mounted in the housing assembly. The first and second dynamic seals sealingly engage first and second portions of the piston over areas substantially equivalent to the sealing areas of the second and first seats, respectively.

An aircraft buffer cooling system is also provided for use in conjunction with a gas turbine engine of the type that includes first and second compressor stages. In one embodiment, the aircraft buffer cooling system includes a lubricated bearing assembly, a heat exchanger fluidly coupled to the lubricated bearing assembly and configured to supply cooled air thereto, and a pressure balanced valve assembly. The pressure balanced valve assembly includes a housing assembly having first and second seats. A flow passage is formed through the housing assembly and has a first inlet configured to be fluidly coupled to the second compressor stage, a second inlet configured to be fluidly coupled to the first compressor stage, and an outlet fluidly coupled to an inlet of the heat exchanger. A piston is slidably mounted in the housing assembly for movement between: (i) a first position wherein the piston contacts the second seat to restrict fluid flow from the second inlet to the outlet, and (ii) a second position wherein the piston contacts the first seat to restrict fluid flow from the first inlet to the outlet. A first dynamic seal sealingly engages a first portion of the piston over an area substantially equivalent to the sealing area of the second seat, and a second dynamic seal sealingly engages a second portion of the piston over an area substantially equivalent to the sealing area of the first seat.

### BRIEF DESCRIPTION OF THE DRAWINGS

At least one example of the present invention will hereinafter be described in conjunction with the following figures, wherein like numerals denote like elements, and:

FIG. 1 is functional schematic of an air buffer cooler system and a gas turbine engine in accordance with an exemplary embodiment; and

FIGS. 2 and 3 are simplified cross-sectional views of an exemplary pressure balanced valve assembly in first and second positions, respectively, suitable for deployment within the air buffer cooler system shown in FIG. 1.

### DETAILED DESCRIPTION

The following Detailed Description is merely exemplary in nature and is not intended to limit the invention or the application and uses of the invention. Furthermore, there is no intention to be bound by any theory presented in the preceding Background or the following Detailed Description.

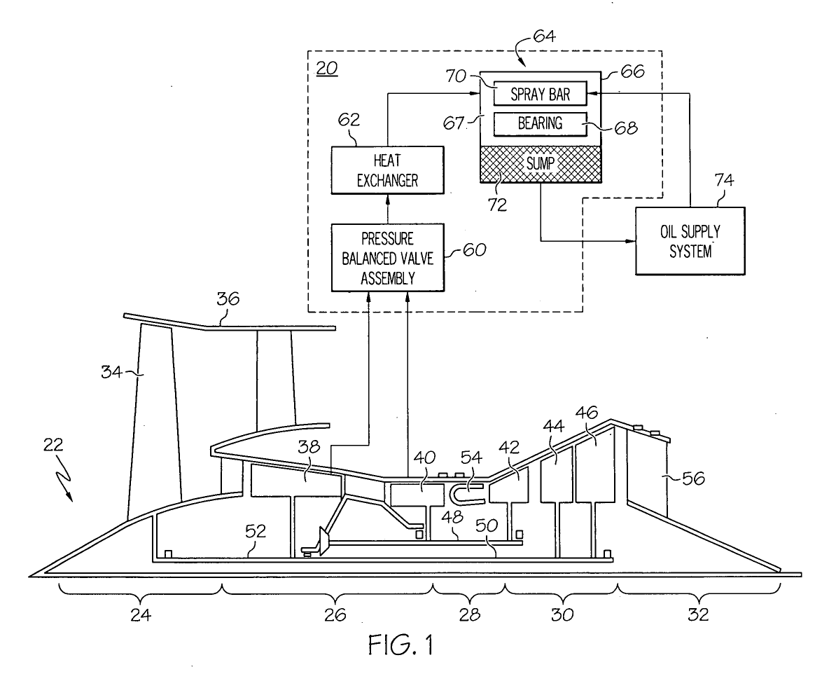

FIG. 1 is a functional schematic of an aircraft buffer cooler system 20 in accordance with an exemplary embodiment of the present invention. By way of contextual example only, aircraft buffer cooler system 20 is illustrated in conjunction with a gas turbine engine (GTE) 22 of the type commonly deployed on an aircraft. In this particular example, GTE 22 assumes the form of a three spool turbofan engine including an intake section 24, a compressor section 26, a combustion section 28, a turbine section 30, and an exhaust section 32. Intake section 24 includes a fan 34 mounted in a fan case 36. Compressor section 26 includes one or more compressors (e.g., an intermediate pressure (IP) compressor 38 and a high pressure (HP) compressor 40), and turbine section 30 includes one or more turbines (e.g., an HP turbine 42, an IP turbine 44, and a low pressure (LP) turbine 46), which may be disposed in axial flow series. HP compressor 40 and HP turbine 42 are mounted on opposing ends of an HP shaft or spool 48; IP compressor 38 and IP turbine 44 are mounted on opposing ends of IP spool 50; and fan 34 and LP turbine 46 are mounted on opposing ends of a LP spool 52. LP spool 52, IP spool 50, and HP spool 48 are substantially co-axial. That is, LP spool 52 may extend through a longitudinal channel provided through IP spool 50, and IP spool 50 may extend through a longitudinal channel provided through HP spool 48.

During operation of gas turbine engine 22, air is drawn into intake section 24 and accelerated by fan 34. A portion of the accelerated air is directed through a bypass section (not shown) disposed between fan case 36 and an engine cowl (also not shown) to provide forward thrust. The remaining portion of air exhausted from fan 34 is directed into compressor section 26 and compressed by IP compressor 38 and HP compressor 40. The compressed air then flows into combustion section 28 wherein the air is mixed with fuel and combusted by a plurality of combustors 54 (only one of which is shown in FIG. 1). The combusted air expands rapidly and flows through turbine section 30 thereby rotating turbines 42, 44, and 46. The rotation of turbines 42, 44, and 46 (and, therefore, of spools 48, 50, and 52) drives the rotation of HP compressor 40, IP compressor 38, and fan 34, respectively. Finally, after passing through turbine section 30, the air is exhausted through an exhaust nozzle 56 mounted in exhaust section 32 to provide addition forward thrust.

In the exemplary embodiment illustrated in FIG. 1, aircraft buffer cooler system 20 includes three main components, namely, a pressure balanced valve assembly 60, a heat exchanger 62 (e.g., a buffer cooler), and at least one lubricated bearing assembly 64. Bearing assembly 64 includes a bearing housing 66, at least one bearing 68 mounted within bearing housing 66, a spray bar 70, a sump 72 formed in the bottom of bearing housing 66, and an air cavity 67 formed within bearing housing 66 above sump 72. An outlet of sump 72 is fluidly coupled to an inlet of an oil supply system 74, and an outlet of oil supply system 74 is fluidly coupled to an inlet of spray bar 70 to complete an oil circulation circuit. During operation, oil supply system 74 draws oil from sump 72 and supplies the oil to the inlet of spray bar 70, which then directs the oil over bearing 68. This process is continually repeated to maintain bearing 68 in a lubricated state. Oil supply system 74 may include any number of components suitable for performing this function (e.g., one or more supply pumps, oil tanks, heat exchangers, filters, etc.), which are conventional in the field and thus not described herein. Although bearing assembly 64 is illustrated as independent from GTE 22 in FIG. 1, it will be appreciated that bearing assembly 64 may be incorporated into GTE 22 in actual implementations. In this case, bearing 68 may support one or more rotating components of GTE 22, such as LP spool 52, IP spool 50, and/or HP spool 48. Although not shown in FIG. 1 for clarity, bearing assembly 64 further includes a plurality of seals, such as carbon seals. When properly energized, the seals of bearing assembly 64 minimize or prevent the leakage of oil. The pressure margin across the seals of bearing assembly 64, and therefore the air pressure within air cavity 67, is preferably maintained within a desired range to ensure that the seals remain properly energized.

Pressure balanced valve assembly 60 is fluidly coupled to at least two stages of one or more of the compressors included within GTE 22. In the illustrated exemplary embodiment, pressure balanced valve assembly 60 is fluidly coupled to and draws bleed air from: (i) a first selected compressor stage within IP compressor 38, and (ii) a second selected compressor stage within HP compressor 40. In an actual implementation of buffer cooler system 20, the first and second selected compressor stages may be, for example, the 4^{th} and 6^{th} compressor stages, respectively. As appearing herein, the first and second compressor stages to which pressure balanced valve assembly 60 is fluidly coupled may be referred to as a “lower compressor stage” and a “higher compressor stage,” respectively. This terminology is utilized only to indicate that the air pressure within first selected compressor stage (the “lower compressor stage”) is typically lower than that within the second selected compressor stage (the “higher compressor stage”). In certain implementations, the lower compressor stage may assume the form of a first pressure tap (e.g., one or more apertures) formed through a compressor housing at a first location, and the high compressor stage may assume the form of a second pressure tap (e.g., one or more apertures) formed through the compressor housing at a second location downstream of the first location.

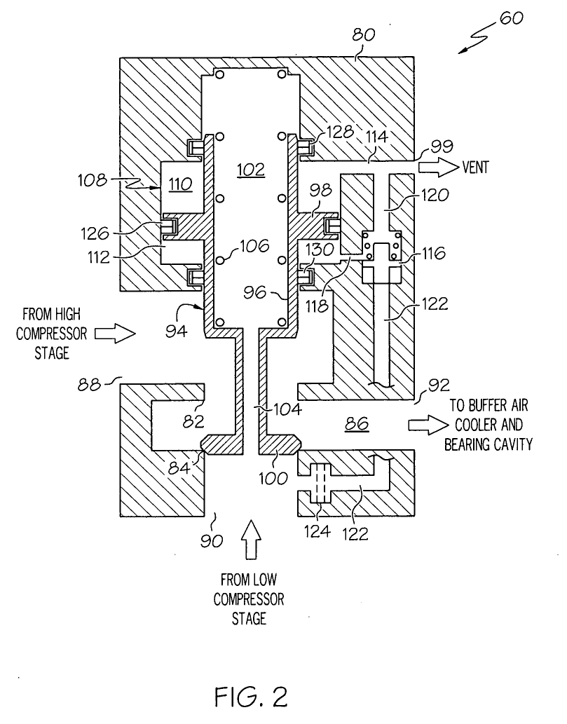

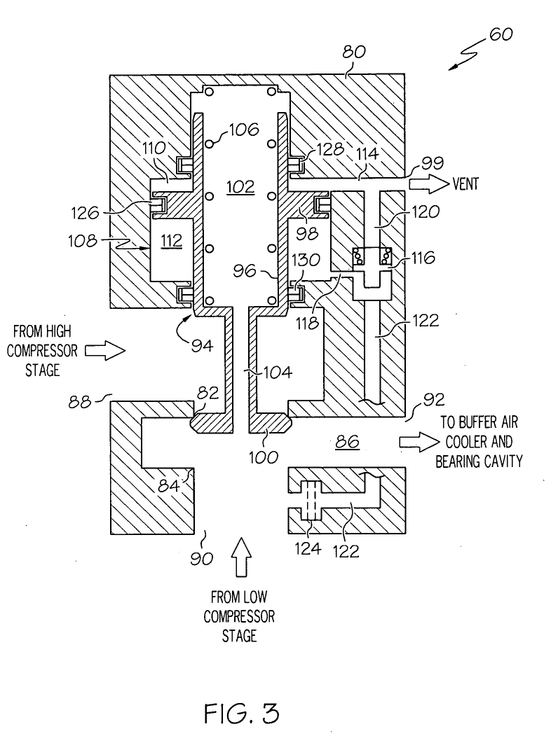

In accordance with a preferred group of embodiments, pressure balanced valve assembly 60 is configured to normally route pressurized air from the selected higher compressor stage (e.g., the 6^{th} compressor stage) to heat exchanger 62 and, therefore, to air cavity 67 of bearing assembly 64. When air pressure within the selected higher compressor stage (e.g., the 6^{th} compressor stage) surpasses a predetermined threshold, pressure balanced valve assembly 60 then blocks pressurized airflow from the selected higher compressor stage to bearing assembly 64 and instead routes airflow from the selected lower compressor stage (e.g., the 4^{th} compressor stage) to bearing assembly 64. In this manner, pressure balanced valve assembly 60 supplies bearing assembly 64 with pressurized air from: (i) the higher compressor stage when the air pressure therein is more suitable for pressuring bearing assembly 64 as is typically the case during low engine speed conditions; and (ii) from the lower compressor stage when the air pressure therein is more suitable for pressuring bearing assembly 64 as is typically the case during high engine speed conditions. In this manner, valve assembly 60 maintains the pressure within bearing assembly 64 within a desired range during operation of GTE 22 and, in so doing, maintains the seals of bearing assembly 64 in a properly energized state. As a non-limiting example, the predetermined threshold may be between approximately 55 and approximately 65 pounds per square inch. An exemplary embodiment of pressure balanced valve assembly 60 will be described below in conjunction with FIGS. 2 and 3.

FIGS. 2 and 3 are simplified cross-sectional views of pressure balanced valve assembly 60 in first and second positions, respectively, in accordance with an exemplary embodiment. Pressure balanced valve assembly 60 includes a housing assembly 80 having first and second seats 82 and 84. A flow passage 86 is formed through housing assembly 80 and includes a first inlet 88, a second inlet 90, and an outlet 92. As indicated in FIGS. 2 and 3, and as discussed above, first inlet 88 and second inlet 90 are conveniently fluidly coupled to a higher compressor stage and a lower compressor stage, respectively, of GTE 22 (FIG. 1); and outlet 92 is conveniently fluidly coupled to heat exchanger 62 (FIG. 1). Although illustrated as a unitary body in FIGS. 2 and 3, housing assembly 80 may include any suitable number of housing structures, which may or may not be rigidly joined together.

A piston 94 is slidably mounted within housing assembly 80 for movement between a first position (FIG. 2) and a second position (FIG. 3). In the illustrated exemplary embodiment, piston 94 includes a generally cylindrical piston body 96, a radial flange 98, and a poppet head 100. Piston body 96, radial flange 98, and poppet head 100 are fixedly joined together and are preferably formed as a single machined piece. In the first position (FIG. 2), poppet head 100 contacts second seat 84 to generally block pressurized airflow from second inlet 90 to outlet 92 while simultaneously permitting pressurized airflow from first inlet 88 to outlet 92 and, therefore, from the higher GTE compressor stage to air cavity 67 of bearing assembly 64 (FIG. 1). Conversely, in the second position (FIG. 3), poppet head 100 contacts first seat 82 to generally block pressurized airflow from first inlet 88 to outlet 92 while permitting pressurized airflow from second inlet 90 to outlet 92 and, therefore, from the lower GTE compressor stage to bearing air cavity 67 (FIG. 1). Piston 94 cooperates with housing assembly 80 to define a pressure balance cavity 102 that resides, at least partially, within piston body 96. A longitudinal channel 104 is formed through poppet head 100 and fluidly couples pressure balance cavity 102 to second inlet 90 and, therefore, to the lower compressor stage upstream thereof. A spring 106 is disposed within pressure balance cavity 102 and biases piston 94 toward the first position (FIG. 2).

Radial flange 98 of piston 94 resides within an actuator chamber 108 provided within housing assembly 80. Radial flange 98 partitions actuator chamber 108 into a first sub-chamber 110 and a second sub-chamber 112. Sub-chamber 110 is fluidly coupled to a low pressure source (e.g., ambient) via a first flow passage 114 and vent 99, and sub-chamber 112 is fluidly coupled to a switching valve 116 via a second flow passage 118. Switching valve 116 is, in turn, fluidly coupled to second inlet 90 via a third flow passage 122 and to first flow passage 114, and therefore to the low pressure source, via a fourth flow passage 120. In the illustrated exemplary embodiment, switching valve 116 assumes the form of a spring-loaded poppet; however, switching valve 116 may assume various other forms in alternative embodiments. If desired, a filter may be disposed within fourth flow passage 122 as indicated in FIGS. 2 and 3 at 124. To prevent leakage between sub-chambers 110 and 112, a dynamic flange seal 126 (e.g., a filled polymer, carbon, or metallic seal) may be carried by radial flange 98 and sealingly engage an inner surface of housing assembly 80 proximate actuator chamber 108.

As a point of emphasis, valve assembly 60 is pressure balanced to first inlet 88 and to second inlet 90. In the exemplary embodiment illustrated in FIGS. 2 and 3, a first dynamic piston seal 128 and a second dynamic piston seal 130 are mounted between housing assembly 80 and piston body 96 such that radial flange 98 generally resides between seals 128 and 130. Dynamic seal 128 (e.g., a filled polymer, carbon, or metallic seal) sealingly engages piston body 96 to substantially prevent pressurized airflow from second inlet 90 and pressure balance cavity 102 to actuator sub-chamber 110; and dynamic seal 130 (e.g., a filled polymer, carbon, or metallic seal) sealingly engages piston body 96 to substantially prevent leakage from first inlet 88 and flow passage 86 to sub-chamber 112. Notably, first dynamic piston seal 128 sealingly engages a first portion of piston body 96 over an area substantially equivalent to the sealing area of second seat 84; and second dynamic piston seal 130 sealingly engages a second portion of piston body 96 over an area substantially equivalent to the sealing area of the first seat 82. In a preferred group of embodiments, the sealing area of first seat 82 is substantially equivalent to the sealing area of second seat 84. Furthermore, in embodiments wherein first seat 82 has a generally circular geometry, the inner diameter of first seat 82 is preferably substantially equivalent to the inner diameter of second dynamic seal 130. Similarly, in embodiments wherein second seat 84 has a generally circular geometry, the diameter of second seat 84 is preferably substantially equivalent to the inner diameter of first dynamic seal 128. In still further preferred embodiments, a first outer diameter of generally cylindrical piston body 96 is substantially equivalent to the inner diameter of first dynamic seal 128; and a second outer diameter of piston body 96 is substantially equivalent to the inner diameter of second dynamic seal 130. Thus, in embodiments wherein cylindrical piston body 96 is generally characterized by a substantially uniform outer diameter (e.g., the exemplary embodiment shown in FIGS. 2 and 3), the inner diameters of first and second dynamic seals 128 and 130 may be substantially equivalent.

The operation of exemplary pressure balanced valve assembly 60 will now be described in conjunction with FIGS. 2 and 3. Referring initially to FIG. 2, pressure balanced valve assembly 60 is illustrated when the air pressure appearing at second inlet 90 is below a predetermined threshold (e.g., during engine start or flight idle). At this juncture, switching valve 116 resides in the closed position and blocks airflow from second inlet 90 to sub-chamber 112. At the same time, switching valve 116 fluidly couples sub-chamber 112 to vent 99. The force exerted on the annular face of flange 98 by the air within sub-chamber 112, taken in addition to the force exerted on the area of poppet head 100 exposed through second inlet 90, is consequently insufficient to overcome the force exerted on piston 94 by spring 106. The force exerted on piston 94 by the pressurized air within pressure balanced chamber 102 is substantially offset by the force exerted on poppet head 100 by the pressurized air supplied to inlet 90; thus, the pressurized air within pressure balanced chamber 102 does not substantially affect the translational position of piston 94. Furthermore, as actuator sub-chamber 110 and actuator sub-chamber 112 are each ported to vent 99, the net force exerted across flange 98 is substantially zero. Piston 94 thus remains in the first position shown in FIG. 2 under the bias force of spring 106. As previously explained, in the first position, poppet head 100 contacts second seat 84 to generally block pressurized airflow from second inlet 90 to outlet 92 and to generally permit pressurized airflow from first inlet 88 to outlet 92. In this manner, pressure balanced valve assembly 60 routes pressurize air from the higher compressor stage upstream of first inlet 88 to the bearing cavity downstream of outlet 92 when the air pressure appearing at second inlet 90 (and thus within the lower compressor stage) is below the predetermined threshold.

Referring now to FIG. 3, pressure balanced valve assembly 60 is illustrated when the air pressure appearing at second inlet 90 has increased above the predetermined threshold (e.g., during engine takeoff and climb). The force exerted on the poppet of switching valve 116 has exceeded the bias force of the spring within switching valve 116, and switching valve 116 has moved into an open position. Pressurized air is consequently permitted to flow from second inlet 90 through flow passage 122, through switching valve 116, through flow passage 118, and into actuator sub-chamber 112. The force exerted on the annular face of radial flange 98 by the pressurized air within actuator sub-chamber 112 now exceeds the cumulative force exerted on piston 94 by spring 106 and by the pressurized fluid within actuator sub-chamber 110, which is vented to ambient via vent 99. As previously noted, the force exerted on piston 94 by the pressurized fluid within pressure balance cavity 102 is generally balanced by the force exerted on poppet head 100 by the pressurized air flowing into second inlet 90 and through flow passage 86. As a result, piston 94 has moved into the second position (FIG. 3) wherein poppet head 100 contacts seat 82. In this position, poppet head 100 permits airflow from second inlet 90 to outlet 92 and generally blocks airflow from first inlet 88 to outlet 92. Pressure balanced valve assembly 60 thus routes pressurize air from the lower compressor stage upstream of second inlet 90 to the bearing cavity downstream of outlet 92 when the air pressure appearing at second inlet 90 (and thus within the lower compressor stage) is above the predetermined threshold. When the air pressure appearing at second inlet 90 again falls below the predetermined threshold, switching valve 116 closes and piston 94 returns to the first position shown in FIG. 2 and discussed above.

It should thus be appreciated that there has been provided an exemplary embodiment of an aircraft buffer cooler system capable of supplying a bearing assembly with pressurized air within a desired pressure range by routing airflow to the bearing assembly from a higher stage of a GTE compressor (e.g., the 6^{th} stage) during low engine speed conditions and from a lower stage of a GTE compressor (e.g., the 4^{th} stage) during high engine speed conditions. It should further be appreciated that there has been provided an exemplary valve assembly suitable for deployment within such an aircraft buffer cooler system. Notably, in the above-described exemplary embodiment, the valve assembly is pressurized balanced to both the higher compressor stage inlet and the lower compressor stage inlet; as a result, the pressure balanced valve assembly is generally unaffected by air pressure fluctuations that may occur in the higher and lower compressor stages during GTE operation. Additionally, the pressure differential between the high and low compressor stages does not substantially affect the translational position of the main valve (e.g., piston 94 shown in FIGS. 2 and 3).

In the above-described exemplary embodiment, the pressure balanced valve assembly normally resides in the first position (FIG. 2) and is configured to transition to the second position (FIG. 3) when the air pressure appearing at second inlet 90 (and thus the air pressure within the lower compressor stage) exceeds a predetermined threshold. However, in alternative embodiments, the pressure balanced valve assembly may be configured to normally reside in the second position and to transition to the first position under various predetermined criteria; e.g., when the pressure appearing at first inlet 88 (and thus the air pressure within the higher compressor stage) surpasses a predetermined pressure threshold. That is, the pressure balanced valve assembly may be configured to sense either inlet pressure and to normally reside in either of the above-described positions. Furthermore, although the above-described exemplary embodiment employed a switching valve to adjust the air pressure within actuator chamber 108, this is by no means necessary; additional embodiments may utilize other control means (e.g., a solenoid-controlled three way valve) to adjust the air pressure within an actuator chamber and thereby control the translational position of the piston.

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention. It being understood that various changes may be made in the function and arrangement of elements described in an exemplary embodiment without departing from the scope of the invention as set-forth in the appended claims.

What is claimed is:

1. A pressure balanced valve assembly, comprising:
a housing assembly including a first seat and a second seat;
a flow passage formed through the housing assembly and having a first inlet, a second inlet, and an outlet;
a piston slidably mounted in the housing assembly for movement between: (i) a first position wherein the piston contacts the second seat to restrict fluid flow from the second inlet to the outlet, and (ii) a second position wherein the piston contacts the first seat to restrict fluid flow from the first inlet to the outlet;
a first dynamic seal mounted in the housing assembly and sealingly engaging a first portion of the piston over an area substantially equivalent to the sealing area of the second seat; and
a second dynamic seal mounted in the housing assembly and sealingly engaging a second portion of the piston over an area substantially equivalent to the sealing area of the first seat.

2. A pressure balanced valve assembly according to claim 1 wherein the sealing area of the first seat is substantially equivalent to the sealing area of the second seat.

3. A pressure balanced valve assembly according to claim 1 wherein first seat has a generally circular geometry, and wherein the diameter of the first seat is substantially equivalent to the inner diameter of the second dynamic seal.

4. A pressure balanced valve assembly according to claim 3 wherein second seat has a generally circular geometry, and wherein the diameter of the second seat is substantially equivalent to the inner diameter of the first dynamic seal.

5. A pressure balanced valve assembly according to claim 1 wherein the piston comprises:
a generally cylindrical piston body; and
a poppet head fixed coupled to the generally cylindrical piston body, the poppet head contacting: (i) the first seat to generally block fluid flow from the first inlet to the outlet in the first position, and (ii) the second seat to generally block fluid flow from the second inlet to the outlet in the second position.

6. A pressure balanced valve assembly according to claim 5 wherein the generally cylindrical piston body has an outer diameter substantially equivalent to the inner diameter of the first dynamic seal.

7. A pressure balanced valve assembly according to claim 6 wherein the generally cylindrical piston body has an outer diameter substantially equivalent to the inner diameter of the second dynamic seal.

8. A pressure balanced valve assembly according to claim 5 wherein the generally cylindrical piston body includes a pressure balance cavity therein, and wherein the poppet head includes a channel therethrough fluidly coupling the second inlet to the pressure balance cavity.

9. A pressure balanced valve assembly according to claim 8 wherein piston cooperates with the housing assembly to define an actuator chamber within the housing assembly.

10. A pressure balanced valve assembly according to claim 9 wherein the piston further comprises a radial flange fixedly mounted to the generally cylindrical piston body and partitioning the actuator chamber into first and second sub-chambers.

11. A pressure balanced valve assembly according to claim 10 wherein the first dynamic seal substantially prevents fluid leakage from the pressure balance cavity to the first sub-chamber.

12. A pressure balanced valve assembly according to claim 11 wherein the second dynamic seal substantially prevents fluid leakage from the first inlet to the second sub-chamber.

13. A pressure balanced valve assembly according to claim 11 wherein the first sub-chamber is vented to a low pressure source.

14. A pressure balanced valve assembly according to claim 10 further comprising a switching valve fluidly coupled between the second inlet and the second sub-chamber.

15. A pressure balanced valve assembly according to claim 14 wherein the switching valve is movable between: (i) a first position wherein the switching valve substantially blocks fluid flow from the second inlet to the second sub-chamber, and (ii) a second position wherein the switching substantially permits fluid flow from the second inlet to the second sub-chamber.

16. A pressure balanced valve assembly according to claim 10 wherein the radial flange generally resides between the first dynamic seal and the second dynamic seal.

17. A pressure balanced valve assembly, comprising:
a housing assembly including a first seat, a second seat, and an actuator chamber;
a flow passage formed through the housing assembly and having a first inlet, a second inlet, and an outlet;
a piston, comprising:
a piston body slidably mounted in the housing assembly;
a poppet head fixedly coupled to the piston body and configured to move therewith between: (i) a first position wherein the poppet head contacts the second seat to substantially block fluid flow from the second inlet to the outlet, and (ii) a second position wherein the poppet head contacts the first seat to substantially block fluid flow from the first inlet to the outlet; and
a radial flange fixedly coupled to the piston body and partitioning the actuator chamber into first and second sub-chambers, the pressures within the first and second sub-chambers acting on the radial flange to generally determine the translational position of the piston;
a first dynamic seal mounted in the housing assembly and sealingly engaging the piston body to generally prevent fluid leakage from the first inlet to the second sub-chamber; and
a second dynamic seal mounted in the housing assembly and sealingly engaging the piston body to generally prevent fluid leakage from the second inlet to the first sub-chamber.

18. A pressure balanced valve assembly according to claim 17 wherein the area over which the first dynamic seal sealingly engages the piston body is substantially equivalent to the sealing area of the second seat, and the area over which the second dynamic seal sealingly engages the piston body is substantially equivalent to the sealing area of the first seat.

19. An aircraft buffer cooling system for use in conjunction with a gas turbine engine of the type that includes first and second compressor stages, the aircraft buffer cooling system comprising:
a lubricated bearing assembly;
a heat exchanger fluidly coupled to the lubricated bearing assembly and configured to supply cooled air thereto; and
a pressure balanced valve assembly, comprising:
a housing assembly including a first seat and a second seat;
a flow passage formed through the housing assembly and having a first inlet configured to be fluidly coupled to the second compressor stage, a second inlet configured to be fluidly coupled to the first compressor stage, and an outlet fluidly coupled to an inlet of the heat exchanger;
a piston slidably mounted in the housing assembly for movement between: (i) a first position wherein the piston contacts the second seat to restrict airflow from the second inlet to the outlet, and (ii) a second position wherein the piston contacts the first seat to restrict airflow from the first inlet to the outlet;
a first dynamic seal mounted in the housing assembly and sealingly engaging a first portion of the piston over an area substantially equivalent to the sealing area of the second seat; and
a second dynamic seal mounted in the housing assembly and sealingly engaging a second portion of the piston over an area substantially equivalent to the sealing area of the first seat.

20. An aircraft buffer cooling system according to claim 19 wherein the piston is configured to transition from the first position to the second position when the pressure of the air received by the second inlet surpasses a predetermined threshold.
